(19) United States
(12) Patent Application Publication
(10) Pub. No.: US 2010/0192973 A1
(43) Pub. Date: Aug. 5, 2010

(54) EXTREME ULTRAVIOLET LIGHT SOURCE APPARATUS AND CLEANING METHOD

(76) Inventors: Yoshifumi Ueno, Hiratsuka (JP); Osamu Wakabayashi, Hiratsuka (JP)

Correspondence Address: WENDEROTH, LIND & PONACK, L.L.P., 1030 15th Street, N.W.,, Suite 400 East, Washington, DC, 20005-1503, US

(21) Appl. No.: 12/688,139

(22) Filed: Jan. 15, 2010

(30) Foreign Application Priority Data
Jan. 19, 2009 (JP) 2009-008356

(51) Int. Cl. B08B 7/00; H05H 1/00; B05D 3/06

(52) U.S. Cl. 134/1.1; 422/186.3; 422/108; 422/116

(57) ABSTRACT

An extreme ultraviolet light source apparatus that can eliminate debris adhering to a component such as optical elements provided within a chamber. The extreme ultraviolet light source apparatus includes: a chamber in which extreme ultraviolet light is generated; a target material supply unit for supplying a target material into the chamber; a driver laser unit for irradiating the target material with a driver pulse laser beam to generate plasma; a cleaning laser unit for emitting a cleaning pulse laser beam; and a control unit for controlling an irradiation position of the cleaning pulse laser beam emitted from the cleaning laser unit so as to irradiate a component provided within the chamber with the cleaning pulse laser beam to remove debris adhering to a surface of the component.

### CROSS-REFERENCE TO RELATED APPLICATION

The present application claims priority from Japanese Patent Application No. 2009-008356 filed on Jan. 19, 2009, the contents of which are incorporated herein by reference in their entirety.

### BACKGROUND OF THE INVENTION

1. Field of the Invention

The present invention relates to an extreme ultraviolet (EUV) light source apparatus to be used as a light source of exposure equipment, and a method of cleaning a component provided within a chamber, in which EUV light is generated, in the EUV light source apparatus.

2. Description of a Related Art

In recent years, as semiconductor processes become finer, photolithography has been making rapid progress toward finer fabrication. In the next generation, microfabrication at 60 nm to 45 nm, further, microfabrication at 32 nm and beyond will be required. Accordingly, in order to fulfill the requirement for microfabrication at 32 nm and beyond, for example, exposure equipment is expected to be developed by combining an EUV light source for generating EUV light having a wavelength of about 13 nm and reduced projection reflective optics.

As the EUV light source, there is an LPP (laser produced plasma) light source using plasma generated by irradiating a target with a laser beam (hereinafter, also referred to as “LPP type EUV light source apparatus”). The LPP type EUV light source apparatus generates plasma by focusing a driver pulse laser beam on a target, e.g., tin (Sn) present within a vacuum chamber. From the generated plasma, various wavelength components including EUV light are radiated, and a specific wavelength component (e.g., a component having a wavelength of 13.5 nm) among them is selectively reflected and collected by using a collector mirror (EUV collector mirror) and outputted to a device using EUV light such as an exposure unit.

The LPP type EUV light source apparatus has advantages that extremely high intensity close to black body radiation can be obtained because plasma density can be considerably made larger, that the light of only the particular waveband can be radiated by selecting the target material, and that an extremely large collection solid angle of 2π to 4π steradian can be ensured because it is a point light source having substantially isotropic angle distribution and there is no structure such as electrodes surrounding the light source. Therefore, the LPP type EUV light source apparatus is considered to be predominant as a light source for EUV lithography, which requires power of more than several tens of watts.

FIG. 22 is a conceptual diagram showing a configuration of an LPP type EUV light source apparatus to be used as a light source of exposure equipment. By irradiating a target material supplied as liquid droplets or particle droplets into a vacuum chamber with a pulse laser beam from a driver laser apparatus, the target material is excited to turn into plasma. Various wavelength components including EUV light are radiated from the plasma. Accordingly, EUV light having a particular wavelength is reflected and collected by using an EUV collector mirror that selectively reflects a wavelength component of the EUV light, and outputted to an exposure unit. On the reflection surface of the EUV collector mirror, for example, a multilayer coating in which thin coatings of molybdenum (Mo) and thin coatings of silicon (Si) are alternatively stacked (Mo/Si multilayer coating) is formed. The multilayer coating reflects about 60% to 70% of the EUV light having a wavelength of 13.5 nm.

In the LPP type EUV light source apparatus, a part of the target breaks up and flies due to the shock wave at plasma generation or the like, and becomes debris. The debris includes fast ions and residues of the targets that have not turned into plasma. The flying debris adheres to the surfaces of components such as optical elements provided within the vacuum chamber, for example, an EUV collector mirror, a laser beam focusing lens, a mirror, a laser beam entrance window, a spectrum purity filter (SPF), an entrance window of an optical sensor, and so on. Accordingly, the reflectivity or transmittance of the optical elements becomes lower, and a problem that the output of EUV light becomes lower and a problem that the sensitivity of the optical sensor becomes lower occur.

Especially, since the EUV collector mirror is provided to surround the plasma near thereto, neutral particles emitted from the plasma or the target adhere to the reflection surface of the EUV collector mirror, which reduces the reflectivity of the EUV collector mirror, while ions emitted from the plasma scrape off the multilayer coating formed on the reflection surface of the EUV collector mirror by the sputtering action, which reduces the selectivity of the EUV light.

In the present circumstances, as a target material that meets the requirement for the output of the EUV light source apparatus, a metal such as tin (Sn) having high EUV conversion efficiency is considered promising. When the metal adheres to the reflection surface of the EUV collector mirror due to debris, EUV light is absorbed during a round trip in the metal coating. Therefore, assuming that the initial reflectivity R₀ of the EUV collector mirror is 60%, for example, when the light transmittance “T” of the metal coating due to the debris is about 95%, the reflectivity “R” of the EUV collector mirror becomes lower to 54.2% and the decreasing rate of the reflectivity “R” is about 10%.

The EUV collector mirror is very expensive because it is necessary to perform special surface treatment on the reflection surface and high optical accuracy such as high flatness of about 0.2 nm (rms) is required, for example. Further, in view of operation cost reduction of exposure equipment, reduction of maintenance time, and so on, the longer lifetime of the EUV collector mirror is required. The lifetime of the EUV collector mirror in an EUV light source apparatus for exposure is defined as a period until the reflectivity “R” decreases by 10%, for example, and a lifetime of at least one year is required.

In order to hold the decrease of reflectivity of the EUV collector mirror at 10% or less for EUV light having a wavelength of 13.5 nm, an acceptable value of deposition thickness of the metal due to debris is an extremely small value of about 0.75 nm for tin (Sn) and about 5 nm for lithium (Li). Accordingly, various technology of preventing tin from adhering to the EUV collector mirror has been proposed. On the other hand, in order to achieve the lifetime of one year, removal of the adherent tin is also effective and various attempts have been made for cleaning the adherent tin.

As a related technology, Japanese Patent Application Publication JP-P2008-518480A (International Publication WO 2006/049886 A2) discloses an EUV light generating apparatus for introducing a etchant gas into an EUV plasma generation chamber to perform cleaning. The EUV light generating apparatus allows the etchant gas to react with tin to produce a compound, and the compound is gasified and removed. However, in this EUV light generating apparatus, it is necessary to form components within the chamber by employing materials resistant to the etchant gas. Further, in order to secure a sufficient etching rate, it is necessary to generate an etching stimulation plasma, to use an ion accelerator, and to heat an EUV collector mirror. According to JP-P2008-518480A, tin debris can be removed efficiently without causing damage on the multilayer coating, but a distribution of refractive index is produced by the etchant gas within the chamber and the wavefronts of the EUV light and the driver pulse laser beam are distorted. Accordingly, it is difficult to maintain focusing ability of the EUV light and the driver pulse laser beam.

Further, U.S. Patent Application Publication US 2008/0212045 A1 discloses a method for removing contaminations of optical elements of exposure equipment with ultraviolet light, not a pulse laser beam. According to the method, the optical elements are irradiated with ultraviolet light by using a semiconductor light source for performing continuous oscillation such as an UV LED, UV laser diode, or the like, and organic materials such as carbon adhering to the optical elements are subjected to photochemical reaction and thereby removed. However, the ultraviolet light does not photochemically react with a metal such as tin, and has no effect on the metal coating adhering to the EUV collector mirror.

### SUMMARY OF THE INVENTION

The present invention has been achieved in view of the above-mentioned problems. A purpose of the present invention is to provide an extreme ultraviolet light source apparatus that can eliminate debris adhering to a component such as optical elements provided within a chamber, especially, to a reflection surface of an EUV collector mirror. Another purpose of the present invention is to provide a cleaning method to be used in the extreme ultraviolet light source apparatus.

In order to accomplish the above-mentioned purpose, an extreme ultraviolet light source apparatus according to one aspect of the present invention is an apparatus for generating extreme ultraviolet light by irradiating a target material with a driver pulse laser beam to turn the target material into plasma, and the apparatus includes: a chamber, in which the extreme ultraviolet light is generated; a target material supply unit for supplying the target material into the chamber; a driver laser unit for irradiating the target material with the driver pulse laser beam to generate plasma; a cleaning laser unit for emitting a cleaning pulse laser beam; and a control unit for controlling an irradiation position of the cleaning pulse laser beam emitted from the cleaning laser unit so as to irradiate a component provided within the chamber with the cleaning pulse laser beam to remove debris adhering to a surface of the component.

Further, a cleaning method according to one aspect of the present invention is a method of cleaning a component provided in a chamber, in which extreme ultraviolet light is generated, in an extreme ultraviolet light source apparatus for generating the extreme ultraviolet light by irradiating a target material with a driver pulse laser beam to turn the target material into plasma, and the method includes the steps of: emitting a cleaning pulse laser beam from a cleaning laser unit; and irradiating a surface of the component with the cleaning pulse laser beam to scan the surface of the component, and thereby, removing debris adhering to the surface of the component.

Here, the cleaning pulse laser beam may be a pulse laser beam having a wavelength within a range from a vacuum ultraviolet range to an infrared range. Especially, it is preferable that the cleaning pulse laser beam is a pulse laser beam having a wavelength in an ultraviolet range in that the pulse laser beam causes little damage on the multilayer coating of the EUV collector mirror and debris can be efficiently removed.

When the reflection surface of the EUV collector mirror to which debris adheres is irradiated with the pulse laser beam, the debris adhering to the reflection surface can be efficiently removed without causing damage on the multilayer coating of the reflection surface. The reason for that is as follows. The adherent particles (debris) rapidly thermally expand by the energy of the pulse laser beam. Accordingly, acceleration of the adherent particles is generated relative to a material to which the particles adhere. It is considered that the acceleration eliminates the intermolecular force between the adherent particles and the material to which the particles adhere, and thereby, liberate and remove the adhering particles.

According to the present invention, debris can be easily and efficiently removed even at a room temperature and under the condition of vacuum or low vacuum without the need of various incidental technologies such as measures to deal with etchant gas, an etching stimulation plasma unit, an ion acceleration unit, higher temperature of the EUV collector mirror, and so on. Further, by optimizing the irradiation intensity of the pulse laser beam, only the adhering debris can be removed without causing damage on the EUV collector mirror. In this manner, the debris adhering to the surface of the optical element such as the EUV collector mirror is removed, and thereby, the lifetime of the optical element can be extended and the cost of the apparatus can be reduced.

### BRIEF DESCRIPTION OF THE DRAWINGS

FIG. 1 shows a configuration of a laser cleaning apparatus in an LPP type EUV light source apparatus according to the first embodiment of the present invention;

FIG. 2 is a conceptual diagram of an irradiation test apparatus for confirmation of laser cleaning performance according to the present invention;

FIG. 3 is a table showing element analysis results according to XPS (X-ray photoelectron spectroscopy) of a substrate surface in a laser beam non-irradiated region and a laser beam irradiated region of an irradiation sample;

FIG. 4 is a conceptual diagram for explanation of a cleaning principle in the present invention;

FIG. 5 shows a configuration of an LPP type EUV light source apparatus according to the second embodiment of the present invention;

FIG. 6 is a timing chart showing an example of generation timing of EUV light and output timing of a cleaning pulse laser beam in FIG. 5;

FIG. 7 is a main flowchart showing an operation example of the EUV light source apparatus as shown in FIG. 5;

FIG. 8 is a flowchart showing an example of a laser cleaning start determination subroutine as shown in FIG. 7;

FIG. 9 is a flowchart showing another example of the laser cleaning start determination subroutine as shown in FIG. 7;

FIG. 10 is a flowchart showing an example of a laser cleaning subroutine as shown in FIG. 7;

FIG. 11 is a flowchart showing an example of an EUV exposure preparation subroutine;

FIG. 12 shows a configuration of an LPP type EUV light source apparatus according to the third embodiment of the present invention;

FIG. 13 is a flowchart showing an example of a cleaning procedure in the EUV light source apparatus as shown in FIG. 12;

FIG. 14 shows a configuration of an LPP type EUV light source apparatus according to the fourth embodiment of the present invention;

FIG. 15 is a flowchart showing an example of a cleaning procedure in the EUV light source apparatus as shown in FIG. 14;

FIG. 16 shows a configuration of an LPP type EUV light source apparatus according to the fifth embodiment of the present invention;

FIG. 17 is a flowchart showing an example of a laser cleaning subroutine in the fifth embodiment;

FIG. 18 shows a configuration of an LPP type EUV light source apparatus according to the sixth embodiment of the present invention;

FIG. 19 is a flowchart showing an example of a cleaning procedure in the EUV light source apparatus as shown in FIG. 18;

FIG. 20 is a flowchart showing an example of an EUV collector mirror replacement subroutine in the cleaning procedure as shown in FIG. 19;

FIG. 21 shows a configuration of a laser cleaning apparatus in an LPP type EUV light source apparatus according to the seventh embodiment of the present invention; and

FIG. 22 is a conceptual diagram showing a configuration of an LPP type EUV light source apparatus to be used as a light source of exposure equipment.

### DESCRIPTION OF THE PREFERRED EMBODIMENTS

Hereinafter, preferred embodiments of the present invention will be explained in detail by referring to the drawings. The same reference characters are assigned to the same component elements and the explanation thereof will be omitted.

### Embodiment 1

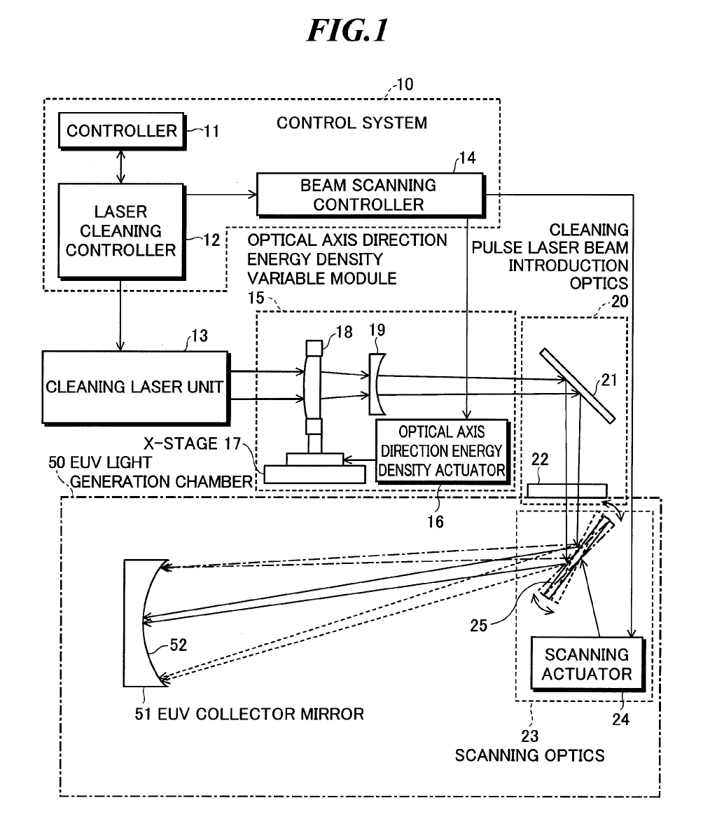

FIG. 1 shows a configuration of a laser cleaning apparatus in an LPP type EUV light source apparatus according to the first embodiment of the present invention. The configuration other than the laser cleaning apparatus is the same as that of an LPP type EUV light source apparatus according to the second embodiment as shown in FIG. 5, for example.

The LPP type EUV light source apparatus according to the first embodiment removes debris by scanning a reflection surface 52 of an EUV collector mirror 51 having a spheroidal shape at predetermined energy density by using the laser cleaning apparatus. For the purpose, the laser cleaning apparatus includes a cleaning laser unit 13 for emitting a cleaning pulse laser beam, an optical axis direction energy density variable module 15 for controlling the convergence state of the cleaning pulse laser beam such that energy density in the optical axis direction of the cleaning pulse laser beam falls within a predetermined range, a cleaning pulse laser beam introduction optics 20 for introducing the cleaning pulse laser beam into an EUV light generation chamber 50, and a scanning optics 23 for scanning a target of cleaning with the cleaning pulse laser beam.

Further, a control system (control unit) 10 of the EUV light source apparatus includes a controller 11 for controlling the respective units of the EUV light source apparatus, a laser cleaning controller 12, and a beam scanning controller 14. The laser cleaning controller 12 controls the cleaning laser unit 13 and the beam scanning controller 14 under the control of the controller 11. The beam scanning controller 14 controls an optical axis direction energy density actuator 16 and a scanning actuator 24.

In an laser cleaning operation, the control system 10 controls the irradiation position of the cleaning pulse laser beam emitted from the cleaning laser unit 13 so as to irradiate the component provided within the EUV chamber 50 with the cleaning pulse laser beam to remove the debris adhering to the surface of the component.

The optical axis direction energy density variable module 15 includes the optical axis direction energy density actuator 16, a convex lens 18, and a concave lens 19. The cleaning pulse laser beam emitted from the cleaning laser unit 13 is transmitted through the convex lens 18 and the concave lens 19 of the optical axis direction energy density variable module 15. In this regard, the optical axis direction energy density actuator 16 moves the convex lens 18 in the optical axis direction, and thereby, the focusing position changes in the optical axis direction. Since the EUV collector mirror 51 is concaved at the center more deeply than in a spherical mirror, the focusing position is changed depending on the laser beam irradiation position, and thereby, the energy density of the cleaning pulse laser beam is adjusted to desired energy density.

The cleaning pulse laser beam introduction optics 20 includes an HR (high reflection) mirror 21 and a window 22 for introducing the cleaning pulse laser beam into the EUV light generation chamber 50. The cleaning pulse laser beam outputted from the optical axis direction energy density variable module 15 is introduced into the EUV light generation chamber 50 via the HR mirror 21 and the window 22.

The cleaning pulse laser beam introduced into the EUV light generation chamber 50 is incident upon the scanning optics 23. The scanning optics 23 includes the scanning actuator 24 and a scanning mirror (rotating mirror) 25. The scanning actuator 24 drives a mirror holder to change the set angle of the scanning mirror 25 around at least two axes, and thereby, the reflection surface 52 of the EUV collector mirror 51 having the spheroidal shape can be scanned with the cleaning pulse laser beam.

As below, the operation of the laser cleaning apparatus will be explained.

When an instruction of debris cleaning using the cleaning pulse laser beam is sent from the controller 11 for controlling the EUV light source apparatus to the laser cleaning controller 12, the laser cleaning controller 12 calculates or measures the distance in the present optical path between the laser beam irradiation position on the reflection surface 52 of the EUV collector mirror 51 and the optical axis direction energy density variable module 15. Then, the laser cleaning controller 12 transmits a control signal for setting the energy density of the cleaning pulse laser beam in the laser beam irradiation position to desired energy density, to the optical axis direction energy density variable module 15. Further, the laser cleaning controller 12 transmits a control signal to the cleaning laser unit 13 so as to cause the cleaning laser unit 13 to oscillate and emit a predetermined number of pulses that can remove the debris.

Next, under the control of the beam scanning controller 14, the scanning actuator 24 changes the laser beam irradiation position on the reflection surface 52 of the EUV collector mirror 51. The laser cleaning controller 12 calculates or measures the distance in the changed optical path between the laser beam irradiation position and the optical axis direction energy density variable module 15. Then, the laser cleaning controller 12 transmits a control signal for setting the energy density of the cleaning pulse laser beam in the laser beam irradiation position to desired energy density, to the optical axis direction energy density variable module 15. Further, the laser cleaning controller 12 transmits a control signal to the cleaning laser unit 13 so as to cause the cleaning laser unit 13 to oscillate and emit a predetermined number of pulses that can remove the debris.

By repeating the above-mentioned operation, the reflection surface 52 of the EUV collector mirror 51 is evenly irradiated with the cleaning pulse laser beam, and thereby, the debris adhering to the reflection surface 52 of the EUV collector mirror 51 can reliably be removed, but no damage is caused on the multilayer coating of the reflection surface 52.

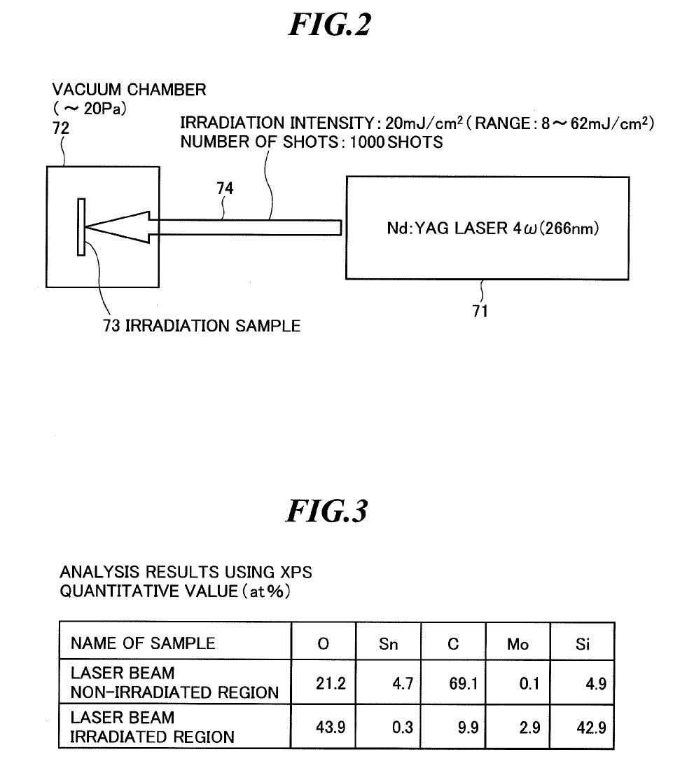

FIG. 2 is a conceptual diagram of an irradiation test apparatus for confirmation of laser cleaning performance according to the present invention. A cleaning laser unit 71 is an Nd:YAG (neodymium doped yttrium aluminum garnet) laser for emitting a pulse laser beam 74 of fourth-harmonic wave (4ω, wavelength: 266 nm) having a pulse width of 10 ns. An irradiation sample 73 is an Mo/Sn multilayer coating mirror (EUV collector mirror) substrate with tin (Sn) in thickness of about 2 nm deposited on the surface thereof by exposure to laser produced Sn plasma radiating EUV light.

The surface of the irradiation sample 73 is irradiated with the pulse laser beam 74 emitted from the cleaning laser unit 71. The temperature of the irradiation sample 73 is a room temperature and the space within a vacuum chamber 72 is in the low vacuum state (˜20 Pa) such that particles separated from the irradiation sample 73 by laser irradiation fly farther. The average value of the irradiation energy density is 20 mj/cm² (range: 8 mj/cm² to 62 mj/cm²) that is considered as a damage threshold value of the Mo/Si multilayer coating, and 1000 shots of irradiation are performed.

FIG. 3 is a table showing element analysis results according to XPS (X-ray photoelectron spectroscopy) of a substrate surface in a laser beam non-irradiated region and a laser beam irradiated region of an irradiation sample. In comparison between the laser beam non-irradiated region and the laser beam irradiated region, XPS signal intensity of tin (Sn) changes from 4.7 at % (corresponding to a thickness of 2 nm) to 0.3 at % (corresponding to a thickness of 0.1 nm or less), and it is confirmed that there is a cleaning effect due to the laser irradiation. In addition, XPS signal intensity of carbon (C) drastically decreases, and it is also confirmed that there is a cleaning effect of carbon (C). Further, the signal intensity of silicon (Si) as an element in the first layer and the signal intensity of molybdenum (Mo) as an element in the second layer on the substrate increase, and therefore, it is found that tin (Sn) and carbon (C) has been cleaned.

Further, it is found that laser cleaning can be performed without causing damage on the multilayer coating in the case where irradiation energy density is equal to or less than 20 mJ/cm² that is considered as the damage threshold value of the Mo/Si multilayer coating. The cleaning rate in this experiment is about 2 nm/1000 shots or more, and higher-speed cleaning can be performed by higher repetition of the laser beam or shorter pulses of the laser beam while the irradiation energy is maintained.

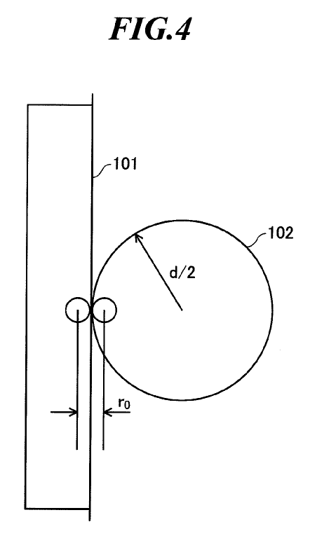

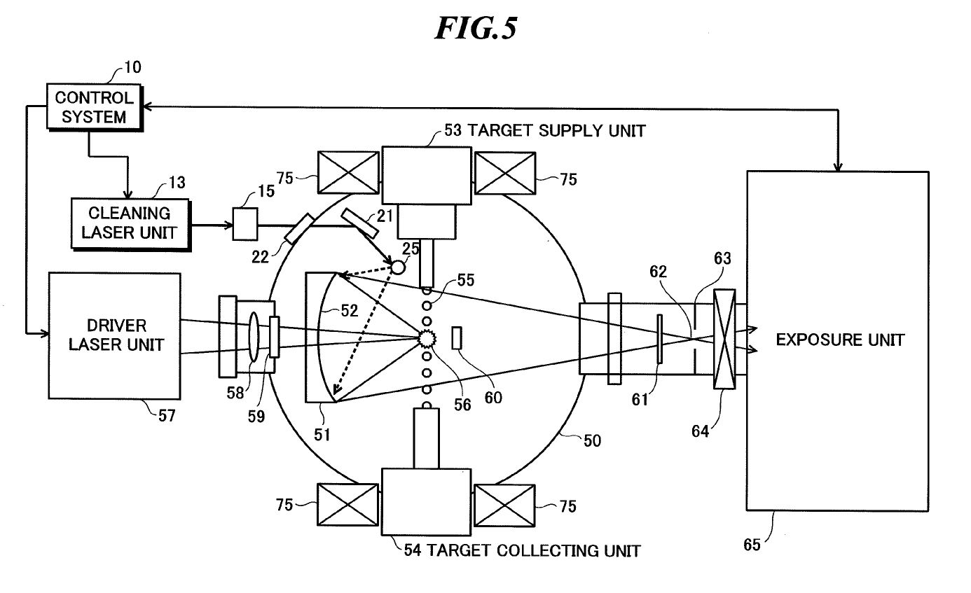

FIG. 4 is a conceptual diagram for explanation of a cleaning principle in the present invention. The basic principle of the present invention is considered as follows. That is, acceleration generated due to rapid thermal expansion of an adherent particle (debris) 102 at irradiation with a pulse laser beam eliminates the intermolecular force between the adherent particle 102 and a substrate surface 101, and thereby, removes the adherent particle (debris) 102. On this account, in the case of the same pulse energy, higher acceleration can be obtained as the pulse width of the laser beam is narrower. For example, irradiation of a pulse laser having a pulse width of 10 ns corresponds to ultrasonic shock at 100 MHz.

The Van der Walls' force Fv acting between two molecules at a large distance “r” is expressed by the following equation (1).

Fv=kr⁻⁷ (1)

where “k” is a predetermined factor.

On the other hand, assuming that the substrate is considered as an infinite number of stacked layers of molecules arranged in an infinite plane, an attraction force caused by the intermolecular forces at a distance “r” from the molecule of the substrate surface is raised in dimension by r³ due to integration of the intermolecular forces in a half of the infinite space, and expressed by the following equation (2).

Fv=4kr⁻⁴ (2)

Therefore, as shown in FIG. 4, the Van der Walls' force acting on a sphere (adherent particle 102) having a radius of d/2 in contact with the molecule of the substrate surface at an intermolecular distance rₒ is expressed by the following equation (3).

$$\begin{matrix}Fv = {\int }_{{r}_{0}}^{d} 4 π {kx}^{- 4} \{ \frac{{d}^{2}}{4} - {( \frac{d}{2} - x )}^{2} \} d x \\ = 2 π \frac{k}{d} \{ {( \frac{d}{{r}_{0}} )}^{2} - 2 ( \frac{d}{{r}_{0}} ) \} \end{matrix} \qquad ( 3 )$$

Here, since d/r₀>>1, the second term within braces is negligible compared to the first term. Therefore, adhesion is expressed by the following equation (4).

Fv=2πkd/r₀² (4)

The mass “m” of the adherent particle 102 is proportional to d³, and acceleration “a” necessary for eliminating the intermolecular force between the adhering particle 102 having a diameter of “d” and the substrate surface 101 is expressed by the following equation (5).

$$a = \frac{Fv}{m} ∝ \frac{1}{{d}^{2}} \qquad ( 5 )$$

By irradiating the reflection surface of the EUV collector mirror with a pulse laser beam that generates the acceleration “a” and causes no damage on the multilayer coating, the adherent particles (debris) can be removed without scratching the reflection surface of the EUV collector mirror.

As explained above, any pulse laser beam having a narrow pulse width (several tens of nanoseconds or less) can remove the adherent particles (debris) on the reflection surface of the EUV collector mirror regardless of its wavelength. For example, even a pulse laser beam emitted from any short-pulse laser such as a CO² laser (wavelength: 10.6 μm) as a driver laser apparatus used for generation of EUV light or YAG laser (wavelength: 1.06 μm) can perform laser cleaning without damaging the multilayer coating of the EUV collector mirror.

However, as the pulse laser beam for performing laser cleaning, a pulse laser beam having a wavelength within a range from a vacuum ultraviolet range to an ultraviolet range is desirable. This is because metals (Sn, Li, and so on) as debris have high absorption for the pulse laser beam in those wavelength ranges. Further, the pulse laser beam in those wavelength ranges does not reach the deep part of the EUV collector mirror, and therefore, can remove the debris adhering to the reflection surface without causing damage on the multilayer coating of the EUV collector mirror.

### Embodiment 2

FIG. 5 shows a configuration of an LPP type EUV light source apparatus according to the second embodiment of the present invention. The LPP type EUV light source apparatus as shown in FIG. 5 includes a control system 10, a laser cleaning apparatus similar to that in the first embodiment as shown in FIG. 1, an EUV light generation chamber 50, an EUV collector mirror 51, a target supply unit 53, a target collecting unit 54, a driver laser unit 57, a focusing optics 58 for a driver pulse laser beam, a laser dumper 60 for the driver pulse laser beam, a spectrum purity filter (SPF) 61, a pinhole plate 63, a gate valve 64, and two electromagnets 75.

The laser cleaning apparatus includes a cleaning laser unit 13, an optical axis direction energy density variable module 15, and a scanning optics having an HR mirror 21 and a scanning mirror (rotating mirror) 25. The pulse laser beam emitted from the cleaning laser unit 13 is introduced into the EUV light generation chamber 50 via the window 22, and incident upon the scanning optics having the HR mirror 21 and the scanning mirror 25. The pulse laser beam incident upon the scanning optics is reflected by the HR mirror 21 and further reflected by the scanning mirror 25, and scans the reflection surface 52 of the EUV collector mirror 51, and thereby, cleans the reflection surface 52.

When a droplet target 55 supplied from the target supply unit 53 reaches the first focal position (plasma emission pint) 56 of the EUV collector mirror 51 having a spheroidal reflection surface, a pulse laser beam is emitted from the driver laser unit 57 in synchronization, and focused and applied onto the droplets via the focusing optics 58 for the driver pulse laser beam and a window 59. Thereby, the droplet target is turned into plasma in the first focal position 56, and EUV light is generated from the plasma. The EUV light is focused on the second focal position 62 by the EUV collector mirror 51. The second focal position 62 is also called an intermediate focusing point (IF).

In FIG. 5, the focusing optics 58 for the driver pulse laser beam includes one focusing lens. However, the present invention is not limited to the embodiment, but, for example, the driver pulse laser beam may be focused by using an off-axis parabolic mirror, or the driver pulse laser beam may be focused by using a combination of a concave lens and a convex lens, a combination of a concave mirror and a convex mirror, or a combination of a lens and a mirror. Further, a part or all of the optical elements of the focusing optics 58 for the driver pulse laser beam may be provided between the window 59 and the first focal position 56.

In the embodiment, the spectrum purity filter (SPF) 61 for transmitting only EUV light having a wavelength of 13.5 nm is provided in an optical path between the EUV collector mirror 51 and the IF 62. Further, the pinhole plate 63 is provided near the IF 62, and EUV light enters an exposure unit 62 via the gate valve 64. Further, in the embodiment, the two electromagnets 75 are provided at the upper part and the lower part of the EUV light generation chamber 50 in the drawing for confinement of ions generated from the plasma in the first focal position 56.

Here, the pulse laser beam emitted from the cleaning laser unit 13 is transmitted through the window 22, and deflected by the HR mirror 21 and the scanning mirror 25 of the scanning optics provided within the EUV light generation chamber 50. In this manner, by scanning the reflection surface 52 of the EUV collector mirror 51 with the cleaning pulse laser beam, the debris deposited on the reflection surface 52 of the EUV collector mirror 51 can be removed.

In the embodiments of the present invention, the case where the reflection surface 52 of the EUV collector mirror 51 is cleaned is explained. However, the present invention is not limited to these embodiments, but the following optical elements and mechanical components may be cleaned.

(a) Example of optical elements: Any optical element for the laser beam or the EUV light such as the window 59 for the driver pulse laser beam, a part of optical elements of the focusing optics 58 for the driver pulse laser beam in the case where it is built in the EUV light generation chamber 50, the window 22 for the cleaning pulse laser beam, the spectrum purity filter (SPF) 61, and an EUV light intensity detector may be cleaned. Further, a window for a measuring instrument for measuring droplet targets and so on may be cleaned.
(b) Examples of mechanical components: The inner wall surfaces of the EUV light generation chamber 50, the target supply unit 53, the target collecting unit 54, the laser dumper 60 for the driver pulse laser beam, and so on may be cleaned.

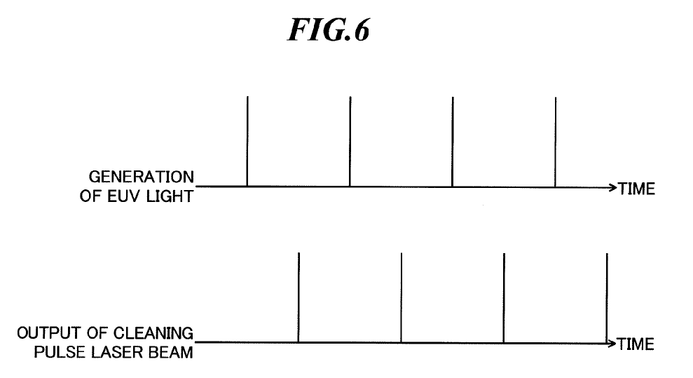

FIG. 6 is a timing chart showing an example of generation timing of EUV light and output timing of a cleaning pulse laser beam in FIG. 5. In the example as shown in FIG. 6, the cleaning laser unit outputs the cleaning pulse laser beam at timing between generation of EUV light and the next generation of EUV light.

Since the EUV light is generated when the droplet target is irradiated with the driver pulse laser beam, the irradiation timing of the driver pulse laser beam and the generation timing of EUV light substantially coincide with each other. Accordingly, in the embodiment, the control system 10 controls the cleaning laser unit 13 to generate the cleaning pulse laser beam at first timing different from second timing at which the driver laser unit 57 generates plural pulses of the driver pulse laser beam.

As described above, by selecting the output timing of the cleaning pulse laser beam different from the generation timing of EUV light, in a period in which EUV light is supplied to the exposure unit 65, i.e., in an operation period in which the exposure unit 65 exposes a wafer to light, laser cleaning can be performed concurrently. Therefore, in the operation period, debris can be prevented from adhering to the reflection surface 52 of the EUV collector mirror 51, and further, debris adhering to the reflection surface 52 can be removed. As a result, the reflectivity of the EUV collector mirror 51 decreases little and the availability factor of the exposure unit 65 is improved.

Further, not limited to the example as shown in FIG. 6, but cleaning may be performed at timing preset according to a program in order to irradiate a desired region in the reflection surface 52 of the EUV collector mirror 51 with a necessary cleaning pulse laser beam. Alternatively, the control system 10 may receive an exposure stop signal from the exposure unit 65 when the exposure unit 65 stops exposure at replacement of masks, replacement of wafers, for example, and perform laser cleaning at that time.

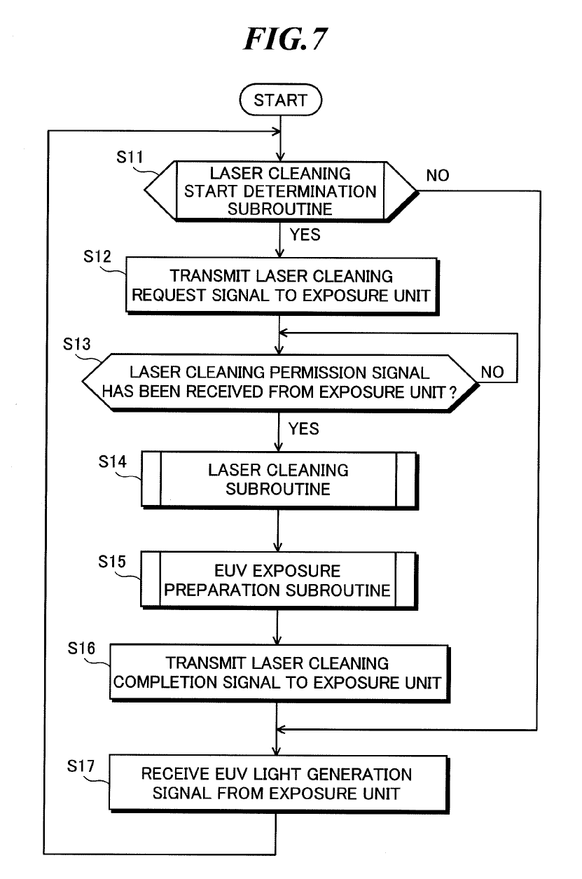

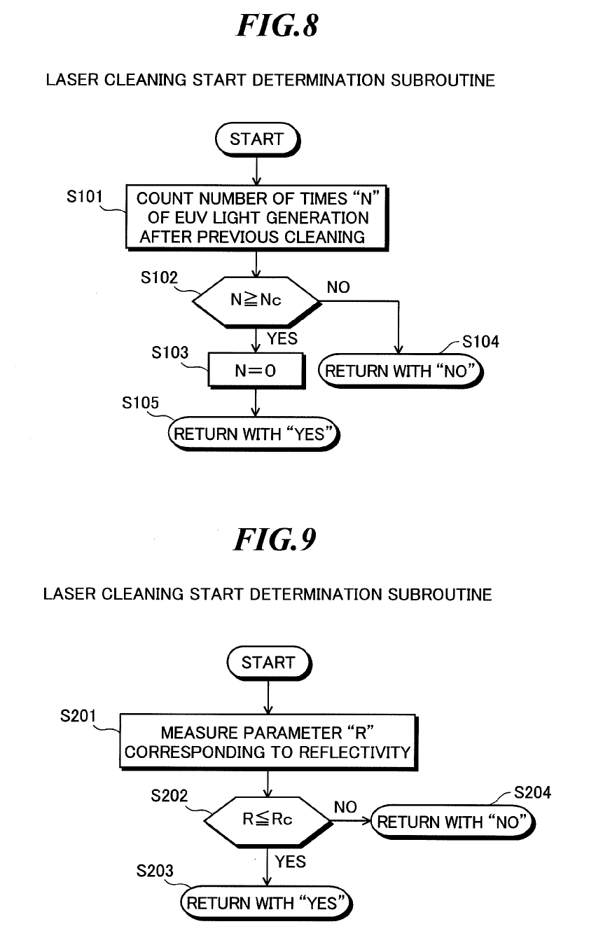

FIG. 7 is a main flowchart showing an operation example of the EUV light source apparatus as shown in FIG. 5, and FIGS. 8-10 are flowcharts showing subroutines in FIG. 7.

First, at step S11 in FIG. 7, a subroutine of determining whether laser cleaning is started or not is executed. As a result, in the case where the determination that the laser cleaning is necessary is made (YES), the process moves to step S12, and in the case where the determination that the laser cleaning is not necessary is made (NO), the process moves to step S17.

At step S12, the control system 10 transmits a laser cleaning request signal for seeking permission of laser cleaning, to the exposure unit 65. Then, at step S13, the control system 10 determines whether a laser cleaning permission signal for giving permission of laser cleaning has been received from the exposure unit 65 or not. In the case where the laser cleaning permission signal has been received, the process moves to step S14, and at step S14, the control system 10 executes a laser cleaning subroutine.

Then, the control system 10 executes an EUV exposure preparation subroutine at step S15. That is, the control system 10 controls the respective units to generate EUV light, adjusts the respective units such that the EUV light is focused by the EUV collector mirror 51 on the desired IF 62 with desired energy, and completes preparation of exposure. Then, at step S16, the control system 10 transmits a laser cleaning completion signal for notifying that the laser cleaning has been completed, to the exposure unit 65. Then, at step S17, the control system 10 receives an EUV light generation signal from the exposure unit 65, and thereby, the EUV light is outputted from the EUV light source apparatus to the exposure unit 65.

FIG. 8 is a flowchart showing an example of a laser cleaning start determination subroutine (step S11 in FIG. 7). The laser cleaning start determination subroutine as shown in FIG. 8 manages laser cleaning based on the number of shots of EUV light emission.

First, at step S101, the control system 10 counts a number of times “N” of EUV light generation after the previous cleaning. Next, at step S102, the control system 10 compares the counted number of times “N” with a predetermined number of shots Nc of EUV light generation that requires laser cleaning. In the case where the counted number of times “N” is equal to or more than the predetermined number of shots Nc (N≧Nc), the process moves to step S103. At step S103, the counted number of times “N” is reset to zero, and at the next step S105, the process returns to the main flow with “YES” which indicates the time to execute laser cleaning. On the other hand, in the case where the counted number of times “N” is less than the predetermined number of shots Nc (N<Nc), the process moves to step S104, and the process returns to the main flow with “NO” which indicates the time not to execute laser cleaning.

FIG. 9 is a flowchart showing another example of the laser cleaning start determination subroutine (step S11 in FIG. 7). The laser cleaning start determination subroutine as shown in FIG. 9 manages laser cleaning based on a parameter corresponding to reflectivity of EUV light.

First, at step S201, the control system 10 controls the respective units to measure a parameter “R” corresponding to the reflectivity of the EUV collector mirror 51. Next, at step S202, the control system 10 compares the measured parameter “R” with a threshold value Rc corresponding to a reflectivity of the EUV collector mirror 51 that requires laser cleaning. In the case where the parameter “R” is equal to or less than the threshold value Rc (R≦Rc), the process moves to step S203, and the process returns to the main flow with “YES” which indicates the time to execute laser cleaning. On the other hand, in the case where the parameter “R” is more than the threshold value Re (R>Re), the process moves to step S204, and the process returns to the main flow with “NO” which indicates the time not to execute laser cleaning.

Here, as the parameter “R” corresponding to the reflectivity of the EUV collector mirror 51, following examples are cited.

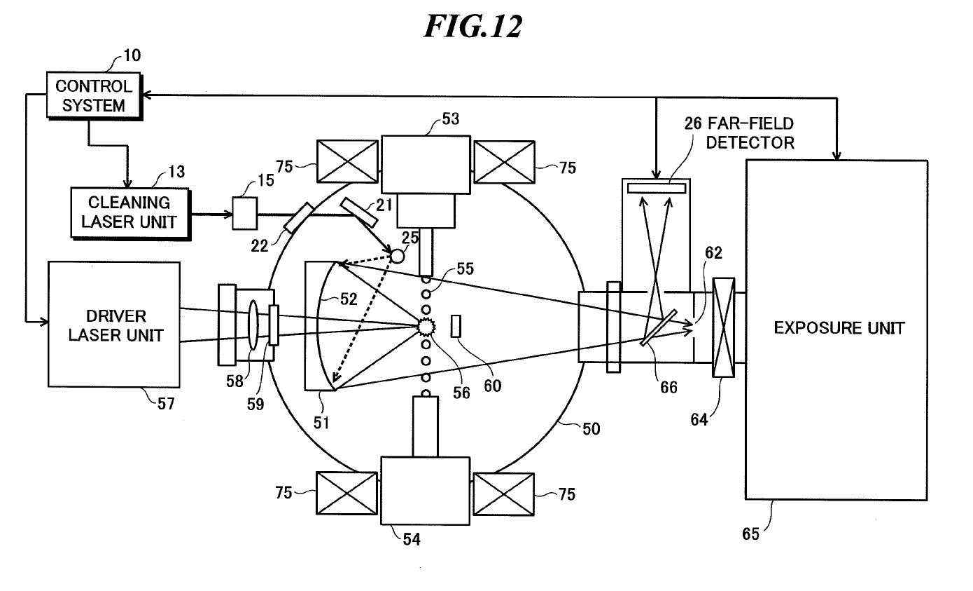

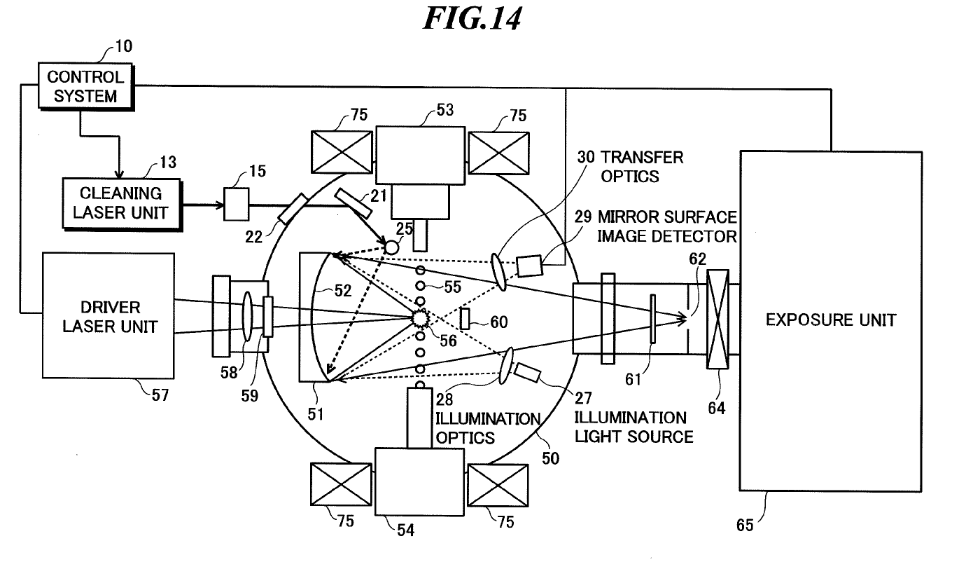

(1) By measuring light intensity Esource of the EUV light at the emission point (first focal position 56) and intensity Eif of the EUV light focused on the IF 62 by the EUV collector mirror 51, a parameter R=Eif/Esource corresponding to reflectivity is obtained.
(2) In the case where a far-field detector, which will be described later in the explanation of FIG. 12, is provided in the EUV light source apparatus, contrast C=(Imax−Imin)/(Imax+Imin) of an intensity distribution in a far-field pattern may be used as the parameter “R”, and contrast requiring laser cleaning may be used as the threshold value Rc.
(3) In the case where the far-field detector is provided in the EUV light source apparatus, a ratio of an average value Eav of an intensity distribution in a far-field pattern to light intensity Esource of the EUV light at the emission point may be obtained, and R=Eav/Esource may be used.
(4) In the case where the far-field detector or a mirror surface image detector, which will be described later in the explanation of FIG. 14, is provided in the EUV light source apparatus, a ratio of a debris adhering area Ade to the entire area “A” may be obtained, and R=Ade/A may be used.

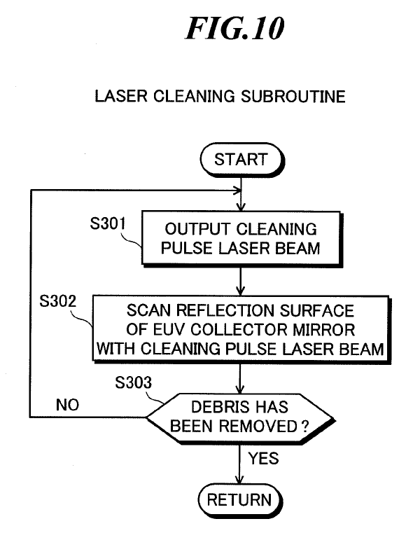

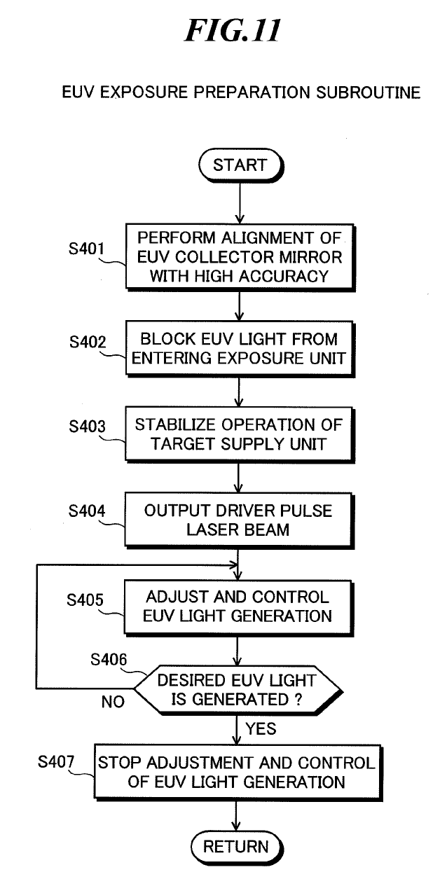

FIG. 10 is a flowchart showing an example of a laser cleaning subroutine (step S14 in FIG. 7).

First, at step S301, the control system 10 controls the cleaning laser unit 13 to output a cleaning pulse laser beam, and at step S302, the control system 10 controls the scanning optics (HR mirror 21 and the scanning mirror 25) to scan the reflection surface 52 of the EUV collector mirror 51 with the cleaning pulse laser beam. Then, at step S303, the control system 10 confirms whether debris has been removed or not. Here, in the case where it is confirmed that the debris has been removed (YES), the process returns to the main flow. On the other hand, in the case where it is not confirmed that the debris has been removed (NO), the process returns to step S301 and laser cleaning is repeated. In this example, the case where the reflection surface 52 of the EUV collector mirror 51 is scanned is explained. However, the present invention is not limited to the example, but a surface of other optical element or a mechanical component may be scanned to remove debris.

FIG. 11 is a flowchart showing an example of an EUV exposure preparation subroutine (step S15 in FIG. 7).

First, at step S401, the control system 10 performs alignment of the EUV collector mirror 51 with high accuracy. For example, the control system 10 adjusts the first focal position 56 of the EUV collector mirror 51 to a desired position without using the EUV light. Next, at step S402, the control system 10 blocks the EUV light with a shutter or the like for preventing the EUV light from entering the exposure unit 65. Then, at step S403, the control system 10 controls the target supply unit 53 to produce droplet targets 55, and stabilizes the operation of the target supply unit 53 to stabilize the droplets.

Then, at step S404, the control system 10 controls the driver laser unit 57 to output a driver pulse laser beam in synchronization with the droplet targets 55 reaching the first focal position 56 of the EUV collector mirror 51. At step S405, the control system 10 adjusts and controls the EUV light generation by detecting the generated EUV light and controlling the operation timing of the target supply unit 53, the oscillation timing of the driver laser unit 57, and the position and posture of the EUV collector mirror 51. At step S406, the control system 10 determines whether desired EUV light has been generated or not. In the case where the desired EUV light has not been generated, the process returns to step S405. On the other hand, in the case where the desired EUV light has been generated, the process moves to step S407, and the control system 10 stops the adjustment and control of EUV light generation, and the process returns to the main flow.

At step S406 of the subroutine, as determination criteria as to whether desired EUV light has been generated or not, the following examples are cited.

(1) Determination is made by detecting whether the generation position of the EUV light falls within a predetermined range near the first focal position 56 of the EUV collector mirror 51 or not by using a CCD or the like.
(2) Determination is made based on whether the intensity distribution in a far-field pattern has desired uniformity or not.
(3) Determination is made based on whether a detection value falls within a predetermined range or not by using a measurement instrument for detecting a position, a size, or energy of an image of the light emission point at the IF 62.

### Embodiment 3

FIG. 12 shows a configuration of an LPP type EUV light source apparatus according to the third embodiment of the present invention. The EUV light source apparatus according to the third embodiment includes a far-field detector 26 for detecting a far-field pattern of the EUV light in order to observe a debris adhering region (condition) on the reflection surface 52 of the EUV collector mirror 51. The rest of the configuration is the same as that of the second embodiment as shown in FIG. 5. Generally, the far-field pattern is defined as an irradiation distribution pattern (beam pattern) of the EUV light that spreads in a farther position from the first focal position 56 than the second focal position (IF) 62 to which an image of the EUV light in the first focal position 56 of the EUV collector mirror 51 is transferred.

In the embodiment, a spectrum purity filter (SPF) 66 is provided between the EUV collector mirror 51 and the IF 62, and a beam pattern in the farther position from the SPF 66 than the position, where the light reflected by the SPF 66 has been once focused, is measured by the far-field detector 26. Thereby, the condition of the reflection surface 52 of the EUV collector mirror 51 can be observed. The far-field detector 26 includes a fluorescent screen and a CCD camera, for example.

The control system 10 detects a position of contamination on the reflection surface 52 of the EUV collector mirror 51 based on the far-field pattern of the EUV light, and controls the irradiation position of the cleaning pulse laser beam emitted from the cleaning laser unit 13 so as to irradiate the position of contamination with the cleaning pulse laser beam to remove debris.

In the image of the reflection surface 52 of the EUV collector mirror 51 detected by the far-field detector 26, an area having high light intensity represents that an amount of adherent debris is small and the reflectivity is high, and an area having low light intensity represents that an amount of adherent debris is large and the reflectivity is low. On the basis of the detection result, the control system 10 controls the scanning optics (HR mirror 21 and the scanning mirror 25) to clean the region to which the debris adhere while scanning the region by using the cleaning pulse laser beam. In the embodiment, the EUV light is utilized to observe the far-field pattern. However, not only the EUV light, but also any light in a wavelength range, in which the reflectivity of the EUV collector mirror 51 changes due to adhesion of debris of tin (Sn) or the like to the reflection surface 52, may be used.

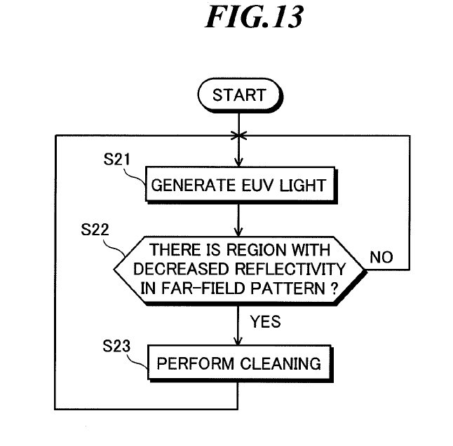

FIG. 13 is a flowchart showing an example of a cleaning procedure in the EUV light source apparatus as shown in FIG. 12.

The control system 10 controls the cleaning laser unit 13 to generate EUV light for inspection (step S21), acquires the far-field pattern of the reflection surface 52 of the EUV collector mirror 51 from the far-field detector 26, and determines whether there is a region having decreased reflectivity or not (step S22). In the case where there is no region having decreased reflectivity, the process returns to step S21 again, and the control system 10 generates the EUV light and monitors adhesion of debris. On the other hand, in the case where there is a region having decreased reflectivity, the control system 10 performs cleaning while scanning the region having decreased reflectivity with the cleaning pulse laser beam (step S23), and then, repeats the cleaning procedure from the start.

Further, the laser cleaning apparatus in the embodiment observes the far-field pattern on a steady basis, and cleans the reflection surface 52 of the EUV collector mirror 51 by scanning the region having the lowest reflectivity with the cleaning pulse laser beam. As a result, the reflection surface 52 of the EUV collector mirror 51 is kept clean, and the contamination adhering to a part of the reflection surface 52 is selectively cleaned, and thereby, the reflectivity distribution can be maintained constantly in a desired condition. Here, the determination of the far-field pattern and the control of the scanning optics can automatically be performed by the control system 10.

### Embodiment 4

FIG. 14 shows a configuration of an LPP type EUV light source apparatus according to the fourth embodiment of the present invention. The LPP type EUV light source apparatus according to the fourth embodiment includes a detector for detecting a debris adhering region (condition) of the EUV collector mirror 51 similarly to the third embodiment, and removes debris adhering to the reflection surface 52 of the EUV collector mirror 51 by employing a cleaning pulse laser beam.

As shown in FIG. 14, the EUV light source apparatus includes an illumination light source 27 for illuminating the reflection surface 52 of the EUV collector mirror 51, an illumination optics 28 for efficiently illuminating the reflection surface 52, a mirror surface image detector 29 having a two-dimensional sensor such as a CCD for detecting an image of the reflection surface 52 in order to observe a debris adhering region (condition) in the reflection surface 52, and a transfer optics 30 for transferring the image of the reflection surface 52 of the EUV collector mirror 51 to a sensor surface of the mirror surface image detector 29. The illumination light source 27 is a light source for generating light having a wavelength that can discriminate between a part to which debris of tin (Sn) or the like adheres and a part to which no debris adheres.

The control system 10 detects a position of contamination on the reflection surface 52 of the EUV collector mirror 51 based on an output signal of the mirror surface image detector 29, and controls the irradiation position of the cleaning pulse laser beam emitted from the cleaning laser unit 13 so as to irradiate the position of contamination with the cleaning pulse laser beam to remove debris.

In the embodiment, by illuminating the reflection surface 52 of the EUV collector mirror 51 and transferring the image of the reflection surface 52 onto the sensor surface of the mirror surface image detector 29 to focus a transfer image, the mirror surface image detector 29 detects the transfer image (mirror surface image) of the reflection surface 52 of the EUV collector mirror 51. Thereby, the position of contamination on the reflection surface 52 of the EUV collector mirror 51 is detected and the region to which debris adheres is made clear, and the region can be scanned with the cleaning pulse laser beam to perform cleaning.

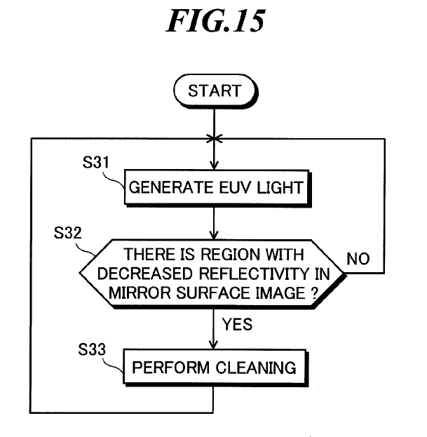

FIG. 15 is a flowchart showing an example of a cleaning procedure in the EUV light source apparatus as shown in FIG. 14.

The control system 10 controls the cleaning laser unit to generate EUV light for inspection (step S31), acquires the image of the reflection surface 52 of the EUV collector mirror 51 from the mirror surface image detector 29, and determines whether there is a region having decreased reflectivity or not (step S32). In the case where there is no region having decreased reflectivity, the process returns to step S31 again, and the control system 10 generates the EUV light and monitors adhesion of debris. In the case where there is a region having decreased reflectivity, the control system 10 performs cleaning while scanning the region having decreased reflectivity with the cleaning pulse laser beam (step S33), and then, repeats the cleaning procedure from the start.

In the embodiment, the case where the reflection surface 52 of the EUV collector mirror 51 is observed once has been explained. However, in the case where the EUV collector mirror 51 is large and so on, debris adhering to the reflection surface 52 may be detected by scanning the entire reflection surface 52 in a field of view including a part of the reflection surface 52 of the EUV collector mirror 51. Further, the laser cleaning apparatus may observe the image of the reflection surface 52 of the EUV collector mirror 51 on a steady basis, and scan the region having the lowest reflectivity on a steady basis to clean the region, or may clean the reflection surface such that the reflectivity distribution is constantly in a desired condition.

### Embodiment 5

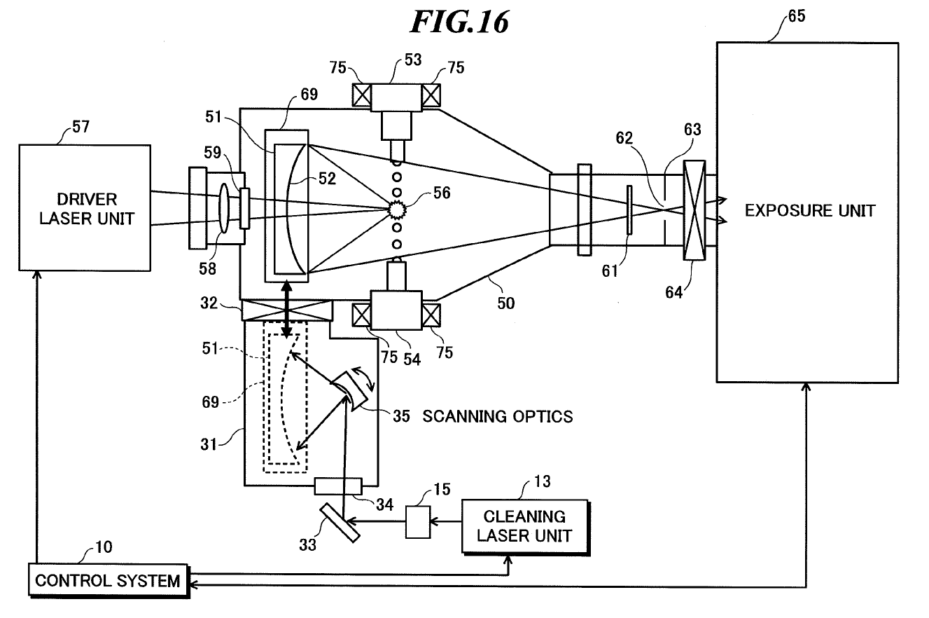

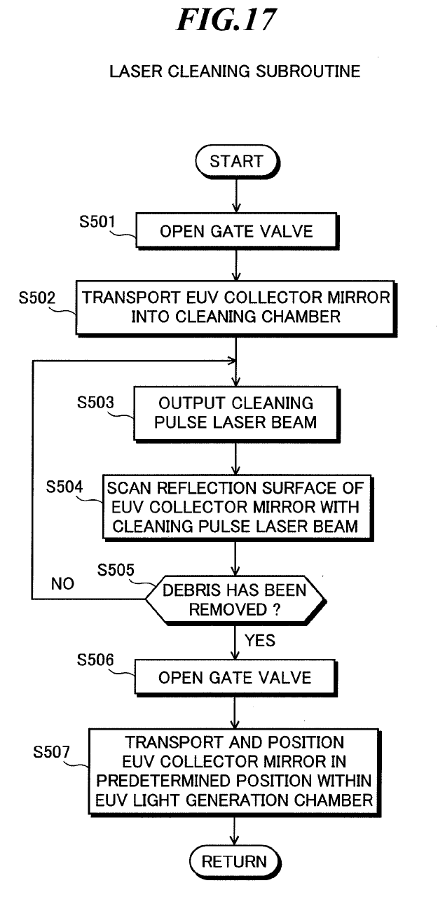

FIG. 16 shows a configuration of an LPP type EUV light source apparatus according to the fifth embodiment of the present invention. The LPP type EUV light source apparatus according to the fifth embodiment moves the EUV collector mirror 51 to an EUV collector mirror cleaning chamber 31, and irradiates the reflection surface 52 of the EUV collector mirror 51 with a pulse laser beam from the cleaning laser unit 13 in the cleaning chamber 31 to remove debris, and then, returns the cleaned EUV collector mirror 51 to an original position within the EUV light generation chamber 50. The EUV light source apparatus does not perform cleaning of the EUV collector mirror 51 during exposure using EUV light within the exposure unit 65, but stops the exposure when cleaning of the EUV collector mirror 51 is necessary, and retracts the EUV collector mirror 51 to the cleaning chamber 31 to perform cleaning.

In the embodiment, the EUV light generation chamber 50 and the cleaning chamber 31 are connected via a gate valve 32. In order to move the EUV collector mirror 51 from the EUV light generation chamber 50 to the cleaning chamber 31 and return the EUV collector mirror 51 to the original set position within the EUV light generation chamber 50, a movement mechanism including a moving stage 69 is provided in the cleaning chamber 31.

The pulse laser beam generated by the cleaning laser unit 13 is transmitted through a window 34 and introduced into the cleaning chamber 31. The control system 10 changes the set angle of the collector mirror, which constitutes a scanning optics 35 for cleaning, around at least two axes, and thereby, the cleaning pulse laser beam scans the reflection surface 52 of the EUV collector mirror 51. In this manner, debris is removed by irradiating the reflection surface 52 of the EUV collector mirror 51 held within the cleaning chamber 31 with the pulse laser beam.

The cleaning procedure in the embodiment is different from the main flow chart of the cleaning procedure in the second embodiment as shown in FIG. 7 only in the operation of the laser cleaning subroutine (step S14). Therefore, as below, an example of the laser cleaning subroutine in the embodiment will be mainly explained.

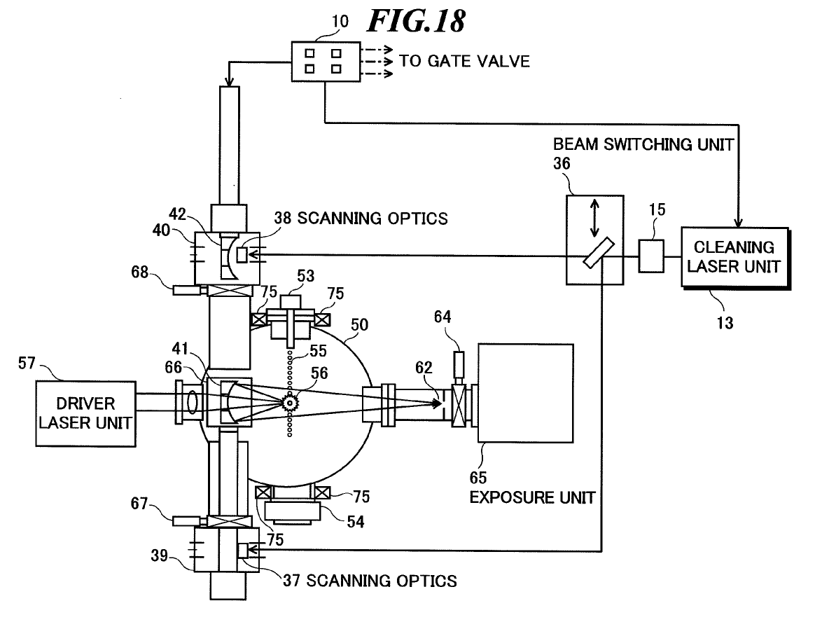

FIG. 17 is a flowchart showing an example of a laser cleaning subroutine in the fifth embodiment. When debris adheres to the EUV collector mirror 51 and the reflectivity of the EUV collector mirror 51 decreases, the control system 10 transmits a signal representing that there is need to enter a cleaning mode of cleaning the EUV collector mirror 51, to the exposure unit 65, and receives a signal representing permission to enter the cleaning mode, from the exposure unit 65.

Then, the control system 10 stops the operation of the target supply unit 53 and the driver laser unit 57, opens the gate valve 32 (step S501), moves the EUV collector mirror 51 mounted on the moving stage 69 together with the moving stage 69 in an arrow direction, transport the EUV collector mirror 51 into the cleaning chamber 31 (step S502), and closes the gate valve 32.

Next, the control system 10 controls the cleaning laser unit 13 to output the cleaning pulse laser beam (step S503). The cleaning pulse laser beam is introduced into the cleaning chamber 31 via the optical axis direction energy density variable module 15, the HR mirror 33, and the window 34. The control system 10 changes the set angle of the collector mirror of the scanning optics 35, and thereby, the cleaning pulse laser beam scans the reflection surface 52 of the EUV collector mirror 51 held in the cleaning chamber 31 and the entire surface of the reflection surface 52 is irradiated with the cleaning pulse laser beam to remove the debris (step S504).

A detector provided within the cleaning chamber 31 detects the reflectivity condition on the reflection surface 52 of the EUV collector mirror 51, and the control system 10 determines whether the debris has been removed or not (step S505). In the case where the removal of the debris is not sufficient, the process returns to step S503 again, and laser cleaning is repeated. On the other hand, in the case where the debris has been sufficiently removed by the laser cleaning, the control system 10 opens the gate valve (step S506), controls the moving stage 69 to transport the cleaned EUV collector mirror 51 to the original position within the EUV light generation chamber 50 and position the EUV collector mirror 51 in a predetermined position (step S507), and closes the gate valve 32. Then, the control system 10 enters the EUV light generation mode again.

In the EUV light generation mode, for example, the control system 10 performs high-accuracy adjustment of alignment of the EUV collector mirror 51, and allows the target supply unit 53 and the driver laser unit 57 to operate in a state that no EUV light enters the exposure unit 65. Then, after the adjustment to generate desired EUV light is completed, the control system 10 outputs an exposure permission signal to the exposure unit 65.

The laser cleaning apparatus in the embodiment performs cleaning of the EUV collector mirror 51 in the cleaning chamber 31 exclusively for EUV collector mirror cleaning and provided outside of the EUV light generation chamber 50. Therefore, there is no interference with the MTV light generation mechanism, and the degrees of freedom of the apparatus and the method become great. Further, cleaning mechanisms, cleaning apparatuses, debris removal confirming means, and so on can be relatively freely selected and combined, and therefore, high-performance laser cleaning apparatus can be formed.

### Embodiment 6

FIG. 18 shows a configuration of an LPP type EUV light source apparatus according to the sixth embodiment of the present invention. The above-mentioned LPP type EUV light source apparatus according to the fifth embodiment includes one EUV collector mirror, and interrupts, when debris adheres, EUV light generation and retracts the EUV collector mirror to the cleaning chamber to perform cleaning. On the other hand, the LPP type EUV light source apparatus according to the sixth embodiment includes two EUV collector mirrors and two cleaning chambers, and performs laser cleaning alternately on the two EUV collector mirrors. Thereby, the operation downtime of the apparatus can be shortened.

The EUV light source apparatus according to the sixth embodiment as shown in FIG. 18 is different from the LPP type EUV light source apparatus according to the fifth embodiment as shown in FIG. 16 in the following points.

(1) A pair of cleaning chambers 39 and 40, a pair of EUV collector mirrors 41 and 42, a pair of scanning optics 37 and 38, a pair of gate valves 67 and 68, and a pair of movement mechanisms for the pair of EUV collector mirrors are provided in two locations at the upper part and the lower part in the drawing. The control system 10 controls the movement mechanisms for the EUV collector mirrors such that, while one collector mirror operates within the EUV light generation chamber 50, the other collector mirror is cleaned in one of the pair of cleaning chambers 39 and 40.
(2) Under the control of the control system 10, the cleaning pulse laser beam emitted from the cleaning laser unit 13 is introduced into one of the scanning optics 37 and 38 by a beam switching unit 36.

An advantage of the embodiment is that the downtime during the laser cleaning of the EUV collector mirror can be eliminated because the cleaned EUV collector mirror 41 can be set within the EUV light generation chamber 50 and exposure can be performed by using the EUV light while the other EUV collector mirror 42 is cleaned.

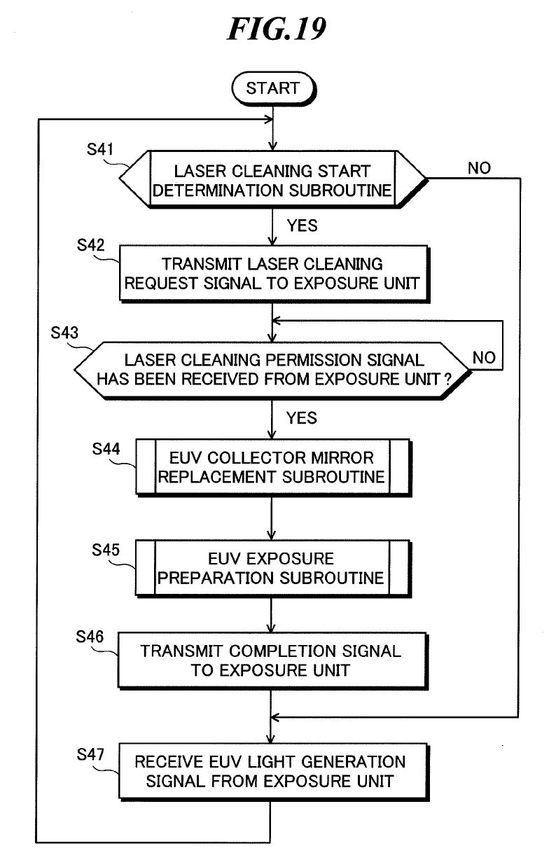

FIG. 19 is a flowchart showing an example of a cleaning procedure in the EUV light source apparatus as shown in FIG. 18. The cleaning procedure in the embodiment is different from the main flow in the second embodiment as shown in FIG. 7 only in that an EUV collector mirror replacement subroutine (step S44) is employed in place of the laser cleaning subroutine (step S14), and the rest of the flow including the subroutines is the same as the flow in the second embodiment.

The cleaning procedure in the embodiment first enters a laser cleaning start determination subroutine (step S41), and whether laser cleaning is started or not is determined at step S41. As a result, in the case where the determination that the laser cleaning is necessary is made (YES), the process moves to step S42. On the other hand, in the case where the determination that the laser cleaning is not necessary is made (NO), the process moves to step S47.

At step S42, the control system 10 transmits a request signal for seeking permission of laser cleaning, to the exposure unit 65. Then, at step S43, the control system 10 determines whether a laser cleaning permission signal has been received from the exposure unit 65 or not. In the case where the laser cleaning permission signal has been received, the process moves to the EUV collector mirror replacement subroutine (step S44). On the other hand, in the case where the laser cleaning permission signal has not been received, the control system 10 waits until receiving the laser cleaning permission signal from the exposure unit 65.

At the EUV collector mirror replacement subroutine (step S44), an operation of replacing the EUV collector mirror 41 to be cleaned with the already cleaned EUV collector mirror 42 and an operation of cleaning the EUV collector mirror 41 are performed. Then, the control system 10 executes an EUV exposure preparation subroutine (step S45) to generate EUV light, adjusts the respective units such that the EUV light is focused on the desired IF 62 with desired energy by the EUV collector mirror 42, and completes preparation of exposure. Then, the control system 10 transmits a completion signal representing completion of the laser cleaning to the exposure unit 65 (step S46), and receives an EUV light generation signal from the exposure unit 65, and thereby, outputs the EUV light to the exposure unit 65 and moves to the normal operation (step S47).

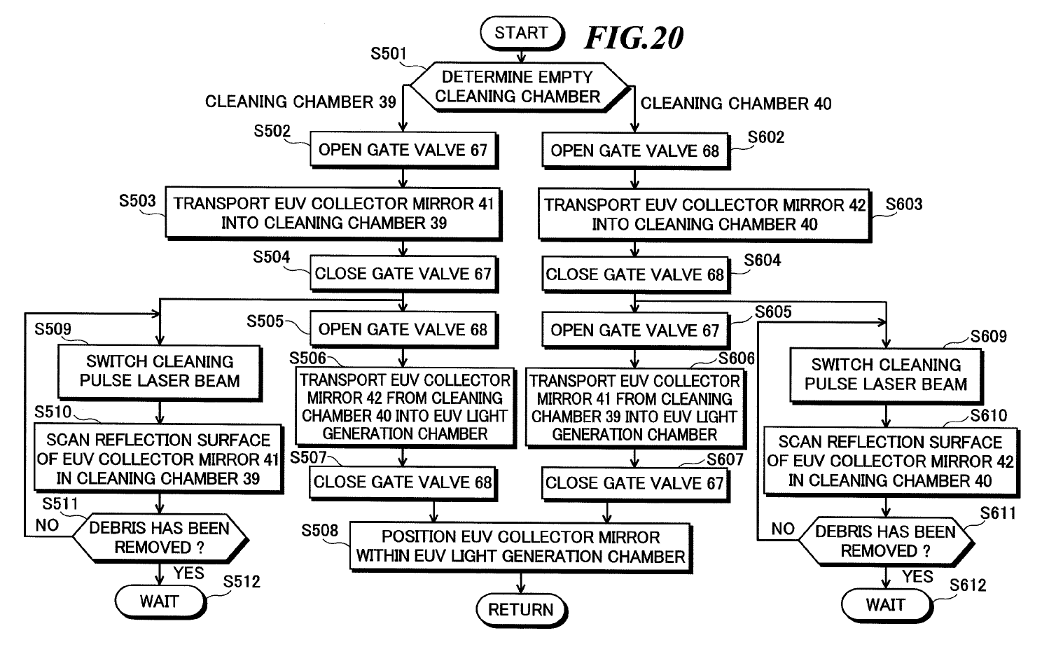

FIG. 20 is a flowchart showing an example of the EUV collector mirror replacement subroutine (step S44 as shown in FIG. 19) in the cleaning procedure. In the EUV collector mirror replacement subroutine, the control system 10 first determines which cleaning chamber is an empty chamber with no EUV collector mirror therein (step S501). In the case where the cleaning chamber 39 is empty, the process moves to a series from step S502. On the other hand, in the case where the cleaning chamber 40 is empty, the process moves to a series from step S602.

In the case where the cleaning chamber 39 is empty, the control system 10 opens the gate valve 67 of the cleaning chamber 39 at step S502, transports the EUV collector mirror 41 into the cleaning chamber 39 at step S503, and closes the gate valve 67 at step S504. Then, the process moves to both step S505 and step S509, and operations are executed in parallel.

In the series from step S505, the control system 10 opens the gate valve 68 (step S505), transports the cleaned EUV collector mirror 42 from the cleaning chamber 40 into the EUV light generation chamber 50 (step S506), and closes the gate valve 68 of the cleaning chamber 40 (step S507). Then, at step S508, the cleaned EUV collector mirror 42 is positioned in a predetermined position within the EUV light generation chamber 50, and the process returns to the main flow.

In the series from step S509 to be simultaneously executed, the control system 10 controls the beam switching unit 36, and thereby, performs switching to introduce the cleaning pulse laser beam emitted from the cleaning laser unit 13 into the cleaning chamber 39, which holds the EUV collector mirror 41 to be cleaned next, at the lower part in the drawing (step S509). Thereby, the cleaning pulse laser beam emitted from the cleaning laser unit 13 scans the reflection surface of the EUV collector mirror 41 transported into the cleaning chamber 39 to clean it (step S510). Next, at step S511, the control system 10 determines whether debris has been removed or not. In the case where the debris has not been removed (NO), the process returns to step S509. On the other hand, in the case where the debris has been removed (YES), the control system 10 waits until the next operation (step S512).

In the case where the determination that the cleaning chamber 40 is empty is made at the first step S501, the process moves to step S602 and the same processing is performed in the following flows symmetrical to the series from step S502 that have been already explained.

That is, in the case where the cleaning chamber 40 is empty, the control system 10 opens the gate valve 68 of the cleaning chamber 40 (step S602), transports the EUV collector mirror 42 that has been used into the cleaning chamber 40 (step S603), and closes the gate valve 68 (step S604). Then, the process moves to both step S605 and step S609, and operations are executed in parallel.

In the series from step S605, the control system 10 opens the gate valve 67 of the cleaning chamber 39 holding the cleaned EUV collector mirror 41 (step S605), transports the cleaned EUV collector mirror 41 from the cleaning chamber 39 into the EUV light generation chamber 50 (step S606), and closes the gate valve 67 of the cleaning chamber 39 (step S607). Then, at step S508, the cleaned EUV collector mirror 41 is positioned in a predetermined position within the EUV light generation chamber 50, and the process returns to the main flow.

In the series from step S609 to be simultaneously executed, the control system 10 controls the beam switching unit 36, and thereby, performs switching to introduce the cleaning pulse laser beam emitted from the cleaning laser unit 13 into the cleaning chamber 40, which holds the EUV collector mirror 42 to be cleaned next, at the upper part in the drawing (step S609). Thereby, the cleaning pulse laser beam emitted from the cleaning laser unit 13 scans the reflection surface of the EUV collector mirror 42 transported into the cleaning chamber 40 to clean it (step S610). Next, at step S611, the control system 10 determines whether debris has been removed or not. In the case where the debris has not been removed (NO), the process returns to step S609. On the other hand, in the case where the debris has been removed (YES), the control system 10 waits until the next operation (step S612).

The LPP type EUV light source apparatus according to the embodiment includes the two EUV collector mirrors, and thereby, while one EUV collector mirror operates and contributes to EUV light generation, cleans the other EUV collector mirror. Therefore, when debris adheres to the operating EUV collector mirror and reflection performance is deteriorated, the EUV collector mirror can be immediately replaced with a clean EUV collector mirror, and thus, the operation downtime of the EUV light source apparatus can be shortened. Further, the available period of the expensive EUV collector mirror is significantly extended, and there is an advantage in reduction of facility cost.

In the above description, as a specific example of an operation of determining whether debris has been removed or not at step S303 in FIG. 10, step S505 in FIG. 17, and step S511 and step S611 in FIG. 20, the laser cleaning start determination subroutine explained with reference to FIG. 9 may be executed in which the determination criterion at step S202 is changed to R≧Rc₂. The Rc₂ in this case is a threshold value corresponding to the reflectivity of the EUV collector mirror required after laser cleaning.

### Embodiment 7

In the above-mentioned embodiments, the cleaning laser unit 13 is separately prepared in addition to the driver laser unit 57 so as to clean the reflection surface 52 of the EUV collector mirror 51. However, in the seventh embodiment, the driver laser unit 57 also serves as a cleaning laser unit.

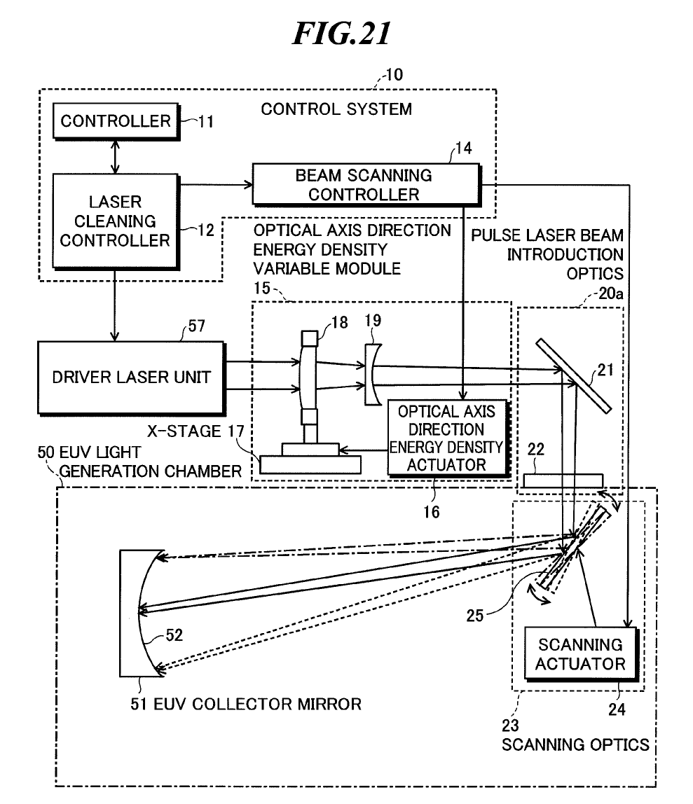

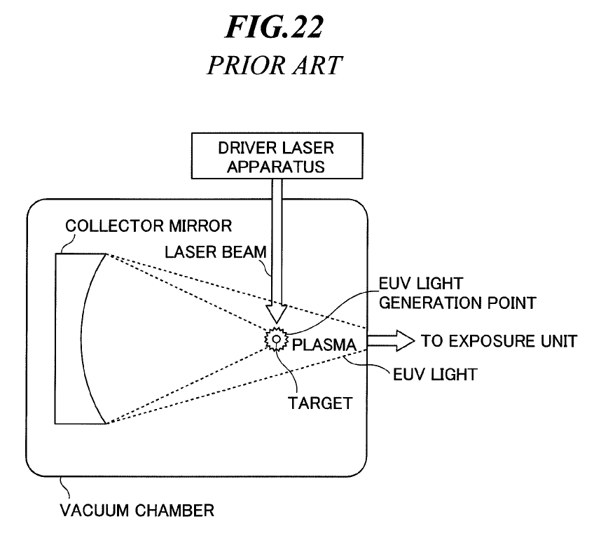

FIG. 21 shows a configuration of a laser cleaning apparatus in an LPP type EUV light source apparatus according to the seventh embodiment of the present invention. The configuration other than the laser cleaning apparatus is the same as the configuration of the LPP type EUV light source apparatus according to the second embodiment as shown in FIG. 5, for example.

The laser cleaning apparatus of the LPP type EUV light source apparatus according to the seventh embodiment includes a driver laser unit 57 for irradiating a target material with a driver pulse laser beam to generate plasma and emitting a cleaning pulse laser beam, an optical axis direction energy density variable module 15 for controlling the convergence state of the pulse laser beam such that energy density in the optical axis direction of the pulse laser beam falls within a predetermined range, a pulse laser beam introduction optics 20a for introducing the pulse laser beam into an EUV light generation chamber 50, and a scanning optics 23 for adjusting the irradiation position such that the target material is irradiated with the driver pulse laser beam and a target of cleaning is scanned with the cleaning pulse laser beam.

Further, a control system (control unit) 10 of the EUV light source apparatus includes a controller 11 for controlling the respective units of the EUV light source apparatus, a laser cleaning controller 12, and a beam scanning controller 14. The laser cleaning controller 12 controls the driver laser unit 57 and the beam scanning controller 14 under the control of the controller 11. The beam scanning controller 14 controls an optical axis direction energy density actuator 16 and a scanning actuator 24.

In a laser cleaning operation, the control system 10 controls the irradiation position of the cleaning pulse laser beam emitted from the driver laser unit 57 so as to irradiate a component provided within the EUV chamber 50 with the cleaning pulse laser beam to remove debris adhering to a surface of the component.

The optical axis direction energy density variable module 15 includes the optical axis direction energy density actuator 16, a convex lens 18, and a concave lens 19. The cleaning pulse laser beam emitted from the driver laser unit 57 is transmitted through the convex lens 18 and the concave lens 19 of the optical axis direction energy density variable module 15. In this regard, the optical axis direction energy density actuator 16 moves the convex lens 18 in the optical axis direction, and thereby, the focusing position changes in the optical axis direction. Since the EUV collector mirror 51 is concaved at the center more deeply than in a spherical mirror, the focusing position is changed depending on the irradiation position and the energy density of the cleaning pulse laser beam is adjusted to desired energy density.

The pulse laser beam introduction optics 20a includes an HR mirror 21 and a window 22 for introducing the cleaning pulse laser beam into the EUV light generation chamber 50. The cleaning pulse laser beam outputted from the optical axis direction energy density variable module 15 is introduced into the EUV light generation chamber 50 via the HR mirror 21 and the window 22 of the pulse laser beam introduction optics 20a.

The cleaning pulse laser beam introduced into the EUV light generation chamber 50 is incident upon the scanning optics 23. The scanning optics 23 includes a scanning actuator 24 and a scanning mirror 25. The scanning actuator 24 drives a mirror holder to change the set angle of the scanning mirror 25 around at least two axes, and thereby, the reflection surface 52 of the EUV collector mirror 51 having the spheroidal shape can be scanned by the cleaning pulse laser beam. The operation of the laser cleaning apparatus is the same as that in the first embodiment as shown in FIG. 1.

Further, in the case of an EUV light source apparatus in which the driver laser apparatus to be used for generating EUV light includes a pre-pulse laser apparatus for generating a pre-pulse laser beam and a main-pulse laser apparatus for generating a main-pulse laser beam, the pre-pulse laser apparatus may be also used as a cleaning laser apparatus. The pre-pulse laser beam expands a droplet target to generate pre-plasma. Further, the pre-plasma and/or the target are irradiated with the main pulse laser beam to generate plasma which radiates EUV light. As a control flow in this case, the main flow as shown in FIG. 7 may be performed.

1. An extreme ultraviolet light source apparatus for generating extreme ultraviolet light by irradiating a target material with a driver pulse laser beam to turn the target material into plasma, said apparatus comprising:
a chamber in which the extreme ultraviolet light is generated;
a target material supply unit for supplying the target material into said chamber;
a driver laser unit for irradiating the target material with the driver pulse laser beam to generate plasma;
a cleaning laser unit for emitting a cleaning pulse laser beam; and
a control unit for controlling an irradiation position of the cleaning pulse laser beam emitted from said cleaning laser unit so as to irradiate a component provided within said chamber with the cleaning pulse laser beam to remove debris adhering to a surface of said component.

2. The extreme ultraviolet light source apparatus according to claim 1, wherein said cleaning laser unit emits a cleaning pulse laser beam including light in an ultraviolet range.

3. The extreme ultraviolet light source apparatus according to claim 1, wherein said control unit controls the irradiation position of the cleaning pulse laser beam to scan the surface of said component, and adjusts energy density of the cleaning pulse laser beam at a same time.

4. The extreme ultraviolet light source apparatus according to claim 1, wherein said component provided within said chamber includes a collector mirror for collecting the extreme ultraviolet light radiated from said plasma.

5. The extreme ultraviolet light source apparatus according to claim 4, further comprising:
a far-field detector for detecting a far-field pattern of the extreme ultraviolet light;
wherein said control unit detects a position of contamination on a reflection surface of said collector mirror based on the far-field pattern of the extreme ultraviolet light, and controls the irradiation position of the cleaning pulse laser beam emitted from said cleaning laser unit so as to irradiate the position of contamination with the cleaning pulse laser beam to remove the debris.

6. The extreme ultraviolet light source apparatus according to claim 4, further comprising:
a mirror surface image detector for detecting an image of a reflection surface of said collector mirror;
wherein said control unit detects a position of contamination on the reflection surface of said collector mirror based on an output signal of said mirror surface image detector, and controls the irradiation position of the cleaning pulse laser beam emitted from said cleaning laser unit so as to irradiate the position of contamination with the cleaning pulse laser beam to remove the debris.

7. The extreme ultraviolet light source apparatus according to claim 1, wherein said cleaning laser unit generates the cleaning pulse laser beam at first timing different from second timing when said driver laser unit generates plural pulses of the driver pulse laser beam.

8. An extreme ultraviolet light source apparatus for generating extreme ultraviolet light by irradiating a target material with a driver pulse laser beam to turn the target material into plasma, said apparatus comprising:
a chamber in which the extreme ultraviolet light is generated;
a target material supply unit for supplying the target material into said chamber;
a driver laser unit for irradiating the target material with the driver pulse laser beam to generate plasma, and emitting a cleaning pulse laser beam; and
a control unit for controlling an irradiation position of the cleaning pulse laser beam emitted from said driver laser unit so as to irradiate a component provided within said chamber with the cleaning pulse laser beam to remove debris adhering to a surface of said component.

9. The extreme ultraviolet light source apparatus according to claim 1, wherein:
said component provided within said chamber includes a collector mirror for collecting the extreme ultraviolet light radiated from said plasma; and
said apparatus further comprises a cleaning chamber including a movement mechanism for retracting said collector mirror from said chamber, and returns said collector mirror to said chamber after a reflection surface of said collector mirror is irradiated with the cleaning pulse laser beam to remove the debris.

10. The extreme ultraviolet light source apparatus according to claim 9, comprising:
a pair of said cleaning chambers and a pair of said collector mirrors;
wherein said control unit controls said movement mechanism such that one of said pair of collector mirrors is cleaned in one of said pair of cleaning chambers while the other of said pair of collector mirrors operates within said chamber.

11. A method of cleaning a component provided in a chamber, in which extreme ultraviolet light is generated, in an extreme ultraviolet light source apparatus for generating the extreme ultraviolet light by irradiating a target material with a driver pulse laser beam to turn the target material into plasma, said method comprising the steps of:
emitting a cleaning pulse laser beam from a cleaning laser unit; and
irradiating a surface of said component with the cleaning pulse laser beam to scan the surface of said component, and thereby, removing debris adhering to the surface of said component.

12. A method of cleaning a component provided in a chamber, in which extreme ultraviolet light is generated, in an extreme ultraviolet light source apparatus for generating the extreme ultraviolet light by irradiating a target material with a driver pulse laser beam to turn the target material into plasma, said method comprising the steps of:
emitting a cleaning pulse laser beam from a driver laser unit; and
irradiating a surface of said component with the cleaning pulse laser beam to scan the surface of said component, and thereby, removing debris adhering to the surface of said component.
